(19) United States
(12) Patent Application Publication
(10) Pub. No.: US 2010/0318380 A1
(43) Pub. Date: Dec. 16, 2010

(54) CONTROLLER FOR TELEMEDICINE APPLICATIONS

(76) Inventors: MARKUS FEESS, Erlangen (DE); Bernd Keuenhof, Kleinsendelbach (DE); Matthias Wedel, Nurnberg (DE)

Correspondence Address: BRINKS HOFER GILSON & LIONE, P.O. BOX 10395, CHICAGO, IL, 60610, US

(21) Appl. No.: 12/795,375

(22) Filed: Jun. 7, 2010

(30) Foreign Application Priority Data
Jun. 15, 2009 (DE) 10 2009 024 920.6

(51) Int. Cl. G06Q 50/00; G06Q 10/00

(52) U.S. Cl. 705/3

(57) ABSTRACT

A controller is configured to allow flexible control of information distribution for telemedical assistance being provided via a telemedicine workplace for a treatment carried out in a treatment room. The controller is configured for receiving medical information from a medical modality or storage system for medical information, forwarding the received medical information to a display of the treatment room, controlling the forwarding of information to the treatment room, forwarding the received medical information to a display of the telemedicine workplace, and controlling the forwarding of the received medical information to the telemedicine workplace.

This application claims the benefit of DE 10 2009 024 920.6 filed Jun. 15, 2009, which is hereby incorporated by reference.

### BACKGROUND

The present embodiments relate to a controller for controlling image distribution.

Invasive medical workplaces (e.g., angiography, cardiology, neurology) are complex installations that may be composed of a plurality of systems supplied by different manufacturers and must be able to display data from the most disparate sources during a treatment.

Increasing specialization in the medical field and increasing cost pressure have led to a situation where recourse is increasingly made to expert medical knowledge that is not available locally (e.g., at the location of the treatment or examination). Recourse to experts who are not locally present may need to happen close to real time so that their expert knowledge may be provided and used in the course of a treatment or an examination. In order to access expertise at a remote location, the preconditions for communication and information exchange are created. A location from which assistance in the form of medical expertise can be provided for a remotely performed treatment or examination is referred to in the following as a telemedicine workplace. In other words, this is a workplace, from which input may be supplied for a patient who is not present locally. Facilities (e.g., for data processing and data transmission) will be provided for implementing the technical support of telemedicine at a telemedicine workplace.

An example of the use of telemedicine in examinations can be found in WO 2003/073922 A1. WO 2003/073922 A1 describes how recourse to remotely available expert medical knowledge is made for a medical eye examination. The publication describes a situation where a technician, rather than a physician, is available locally (e.g., at the patient's location).

In many cases, much more complex medical problems are involved. For example, teams of physicians may be used during operations on central human organs. For constellations of this kind, it is advantageous for the telemedical capabilities to possess a high degree of flexibility. Problems may occur if the available data is extremely large in volume (e.g., when a plurality of medical modalities is used in combination), as a result of which the possibilities of information and data exchange come up against limits.

### SUMMARY AND DESCRIPTION

The present embodiments may obviate one or more of the drawbacks or limitations in the related art. For example, the flexibility of telemedicine during an examination or treatment may be increased.

For the sake of simplicity, reference will henceforth be made in the following to a treatment as a medical workflow. The term “treatment” is to be understood broadly, such that the term includes any intervention for which a physician is required. An examination carried out for purely diagnostic purposes is encompassed within the meaning of “treatment.”

The controller according to the present embodiments controls information distribution for telemedical assistance or support being provided via a telemedicine workplace for a treatment performed in a treatment room. The telemedical assistance may include the assistance of one or more medical experts who are not based at the treatment location. The controller according to the present embodiments is implemented or configured using software, hardware, firmware or a combination thereof The controller may be a processor, computer, server or other device, configured with data stored in non-transitory computer readable media, for performing the acts described herein. The controller is configured to receive medical information such as, for example, images or image streams (i.e., continuously incoming sequences of images), from at least one medical device or medical modality (e.g., an X-ray machine, CT, MR, ECG, and/or ultrasound scanner), or a storage system for medical information (e.g., an image storage system such as PACS). The controller may also be configured for receiving information both from one or more modalities and from one or more storage systems. Information may include images and image streams. In the following, information may also relate to voice information and control information. A modality may be any device that can supply patient information during a treatment.

The controller is also configured to: forward received information to at least one display of the treatment room (e.g., display of a plurality of images on a large-format display or display of a plurality of images on a plurality of displays); control the forwarding of information to the treatment room (e.g., via an input interface or operator console provided in the treatment room); forward received information to at least one display of the telemedicine workplace; and control the forwarding of information to the telemedicine workplace.

The present embodiments permit control of the information flow between a treatment room and one or more telemedicine workplaces. Using the present embodiments, the information flow may be tailored to the specifications of the treatment. The control function may include selecting images or image streams that are routed or forwarded to the treatment room or to the telemedicine workplace. The information may be reduced to the minimum that is required at the respective location. This not only protects the respective physician from unnecessary or distracting information but also reduces the volumes of data to be transmitted, thus bringing advantages with regard to the telemedicine workplace and the network capacities available for the transmission. The information may be forwarded in accordance with characteristics of the network used (e.g., bandwidth and quality-of-service features) in such a way that forwarding may take place in real-time (i.e., immediately) without disruptive delays. This enables a direct or interactive involvement of the physician participating at the telemedicine workplace. The advantages of the present embodiments are illustrated when physicians possessing different expertise take part both in the treatment room and at the telemedicine workplace in a treatment for which a division of tasks exists. For example, a vascular surgeon may perform an operation in the treatment room with a neurologist ready to provide support from the telemedicine workplace. In another example a pathologist may be telemedically involved in a diagnostic or therapeutic intervention (e.g., depending on the assessment of the pathologist whether a therapeutic intervention will follow on from the diagnostic intervention). A team of physicians may also be deployed, where the plurality of physicians participates via telemedicine workplaces, and each of the physicians (e.g., a neurologist, a vascular surgeon, and a pathologist) receives information defined according to a corresponding role or set at the controller.

The control function may serve functions in addition to the selection of information. In one embodiment, the control function adapts or processes images or image streams. For example, images or image streams may be assembled, composed or configured for displaying in the treatment room or at the telemedicine workplace (e.g., for presenting different information on a single large-format display). In this way, the information playback may be optimized at both locations. Also, bandwidth may be saved as a result of transmitting composed image information assembled from multiple sources into one image that is to be transmitted. In one embodiment, the control function may also permit individual information or information blocks to be processed (e.g., transmitted images to be provided with comments or images and other information relating to the images to be linked in some other way so that both can be transmitted together). The forwarding of images to the treatment room may be controlled using an input interface provided in the treatment room. The forwarding to the telemedicine workplace may also to be controllable at least in part from the treatment room using an input interface. This forwarding to the telemedicine workplace may be controllable using the input interface when a treatment that is occurring locally is centrally monitored and the information to be transmitted to the remote location is selected in accordance with the information needed at the remote location and parameters of the network.

This control of the forwarding to the telemedicine workplace from the treatment room may also include only a part of the control function. For example, the information to be transmitted to the telemedicine workplace may be specified from the treatment room, while the configuration or composition of the information may be set up via the telemedicine workplace.

In one embodiment, the forwarding of information to the telemedicine workplace may also be controlled by the telemedicine workplace, where the control may include only a part of the settings. If control may be effected for specific settings both from the treatment room and via the telemedicine workplace, a prioritization may be established (e.g., in favor of the treatment room) in order to avoid inconsistencies.

The control function may be performed in a number of ways including, for example, control via computer or voice control (e.g., voice commands are interpreted and change the settings of the controller). The controller may also be configured for forwarding information other than images and image streams (e.g., information provided by the treating physicians). For example, a voice transmission may take place in both of the directions, enabling the remote physician to talk to the locally present physician using voice information transmitted via the controller and corresponding input and output devices.

### BRIEF DESCRIPTION OF THE DRAWINGS

FIG. 1 shows a schematic representation of one embodiment of controller elements and connections for telemedical applications; and

FIG. 2 shows a detailed representation of one embodiment of an arrangement for telemedicine.

### DETAILED DESCRIPTION OF THE DRAWINGS

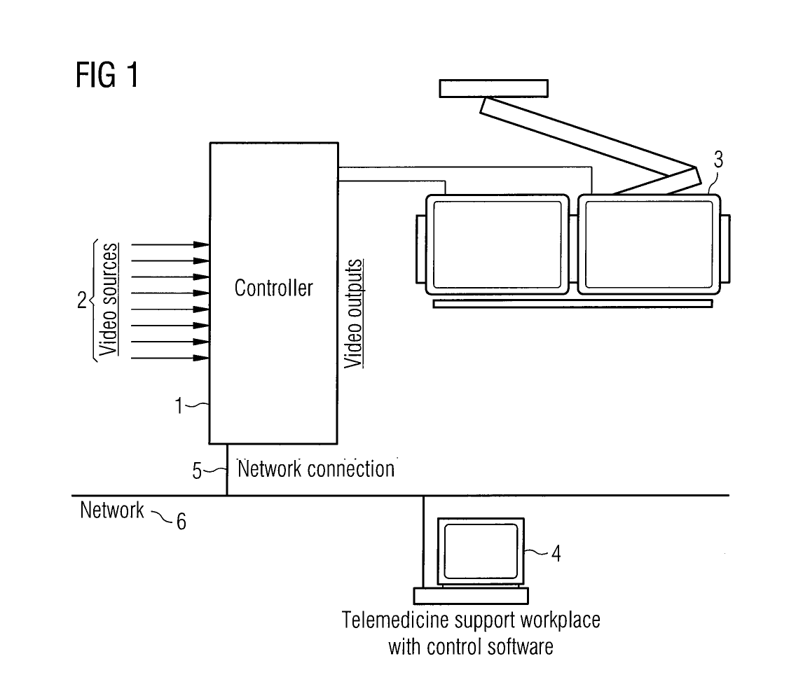

FIG. 1 shows a controller 1 that includes a plurality of video inputs 2. The controller 1 is connected to two displays or monitors 3, which are situated in a treatment room (e.g., an examination room). A single large-format display or a plurality of displays may also be provided instead of the two displays. The controller 1 is also connected to a display 4, which is part of a computer that is situated at a teleworking workplace. The connection to the teleworking workplace is established via a network connection 5, which allows a connection to the telemedicine workplace via a network 6 (e.g., a public network).

The controller 1 (e.g., an image processor 1) has a plurality of input sources on an input side. The plurality of input sources may be visualized on an output side of the controller 1 in different layouts or configurations on one or more high-resolution displays of the treatment room. In addition to this function, the image processor is able to forward the individual input image sources by way of the network connection 5 in different layouts via the network 6 to remote telemedicine workplaces or assistance workplaces (e.g., as an image stream or video). The images that are to be sent to the remote workplace via suitable control software may be selected and composed. An image stream generated in this way in the course of a treatment may be stored or archived in a documentation unit, for example, by storing a video sequence relating to the treatment in a video recorder (e.g., via a video output) or as a video file (e.g., also in conjunction with the comments and instructions transmitted locally or via the telemedicine workplace during the treatment) on a digital storage medium. In addition, data streams (e.g., audio or video) permitted for a set of documentation may also be set using suitable software, since all of the information may not be suitable or available for documentation. The data streams (e.g., audio or video) permitted for a transmission to the teleworking workplace may be set for the respective physician participating at the teleworking workplace using suitable software, since all of the information may not need to be accessible at the teleworking workplace. A video camera (e.g., a webcam), which may be controlled remotely, for example, via intranet or internet, may also be provided. The treatment room or the patient or physician that is present in the treatment room may be observed during the treatment by the physician participating at the telemedicine workplace using the video camera. A microphone and a loudspeaker may also be installed in the examination room in order to transmit voice information to the teleworking workplace.

In one embodiment, a remotely controllable pointing unit (e.g., laser pointer) may be integrated into the video camera or coupled to the video camera. The pointing unit may be controlled by the physician that is participating from a remote location and may thus be used for pointing to a specific region of interest.

Using these measures, a web-based audio/visual telecommunication link may be established to an external diagnostic specialist. In other words, a web-based audio/visual telecommunication link may be established to a diagnostic specialist participating via a teleworking workplace (e.g., initiation via telephone with subsequent connection setup). This enables the physician participating at the teleworking workplace to communicate interactively with the treating physician. Using a video camera that may be remotely controlled by the remote physician, the remote physician sees a live transmission from the examination room and may speak directly to the treating physician or listen to the treating physician. Using the control capability, the external diagnostic specialist may select one or more image sources of interest from all of the image sources and present the one or more image sources of interest on a display at the external diagnostic specialist (e.g., via a web application). The external diagnostic specialist may use the entire examination environment, including all of the image information, interactively at an external workplace to assist the treating physician. In other embodiments, the controller 1 may support the following functions: configuration of a network connection in the context of teleradiology; providing text and audio links; setting up documentation; optional recording of all channels; and releasing specific process steps or segments in the medical workflow.

The external diagnostic specialist participating at the telemedical workplace may listen, see, speak, point, authorize (e.g., release specific process steps), document, select individual images, upload images on the image processor and make them visible to the treating physician (e.g., images from pathology and aids for interpretation of images) and/or set up a connection and involve third parties in the session.

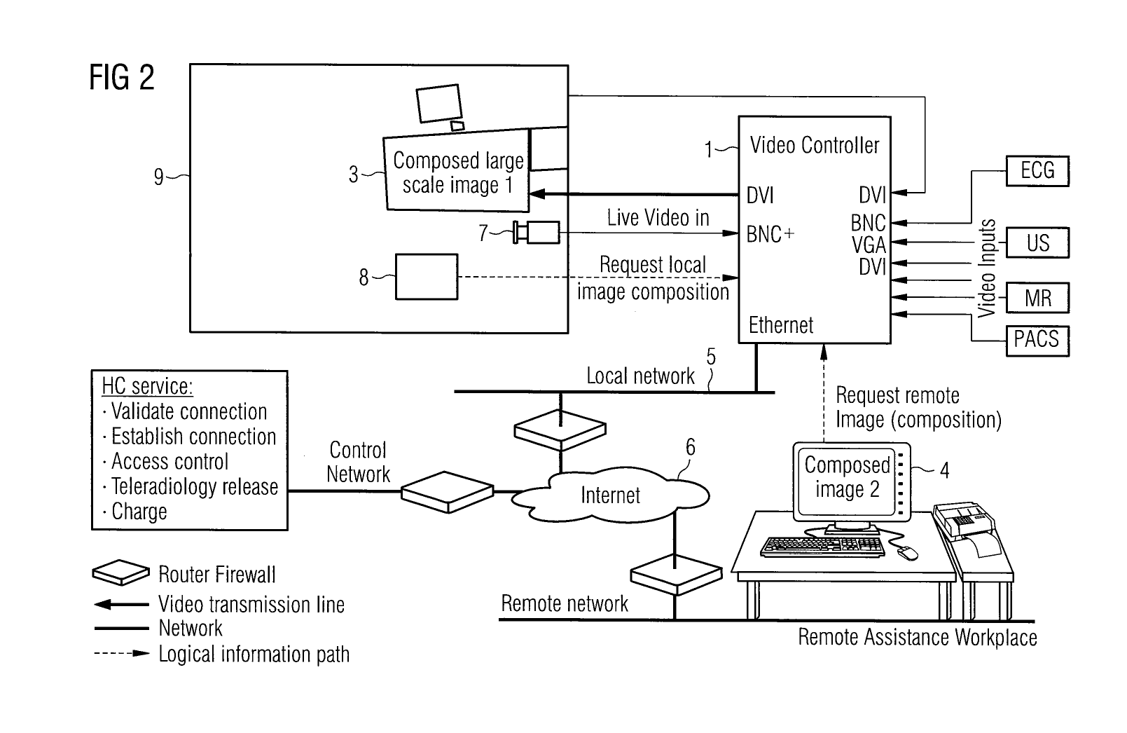

FIG. 2 shows a detailed representation of an arrangement for telemedicine. A plurality of video sources (e.g., ECG, PACS, CT, X-ray, MR, and/or ultrasound) is connected to the controller 1 via different interfaces (e.g., Digital Visual Interface (DVI), Bayonet Nut Connector (BNC), and/or Video Graphics Array (VGA)). The plurality of video sources is combined to form one image, which is displayed on a display 3 (e.g., a large-format display) in a treatment room 9. A connection to the internet 6 is also provided via a local network (e.g., Ethernet 5), through which a telemedicine workplace (e.g., a Remote Assistance Workplace) is reached. Arranged at the telemedicine workplace is a display 4 that displays a second image composed by the controller 1. In addition to the physical path via the local network and the internet, the logical data path to the telemedicine workplace is also indicated using a dashed line in FIG. 2. The treatment room is recorded via a video camera 7. A video stream is also made available to a remotely participating physician. The composition of the displayed image may be controlled from the treatment room using an operator console 8. Additional image information may also be transmitted from the treatment room to the controller 1 via a connection 10. The additional image information may also be used (e.g., by a treating physician) for the consultation process with the remotely participating physician (e.g., markings of tissue sites). For example, both on the side of the treating physician and on the side of the physician participating via the telemedicine workplace, the displays 3, 4 may be coupled with a laser pointer and a camera via the controller 1 in such a way that markings made with the laser pointer on the display 3 are also visualized for the remotely participating physician on the corresponding image also displayed at the telemedicine workplace.

The controller according to the present embodiments has a considerably wider field of application than is shown in the present embodiments. There is a plurality of constellations in the field of medicine where the use of the present embodiments may be beneficial.

For example, the present embodiments may also be used in the context of mobile solutions. In this case, one or more of the data links are wireless transmissions. Thus, the present embodiments may be used for provision of care or for preparatory measures (e.g., for an emergency operation) in an ambulance. Information (e.g., data, images, and voice) is transmitted wirelessly from the ambulance to the controller 1. In the other direction, information may be sent from a stationary medical workplace. This is advantageous, as additional medical expertise may be drawn upon during the transportation.

The subject matter of the present embodiments may be used outside of the medical technology field (e.g., support for local monitoring or control of processes using a remote workplace). For example, the present embodiments may be used for control rooms such that an external supervisor may be called upon (e.g., from a remote workplace) for monitoring a plurality of control rooms. Another example is the monitoring and control of production processes (e.g., manufacturing 3D implants), which are managed with the aid of a remotely located workplace. The production processes may also be controlled at least in part from the remotely located workplace (e.g., starting of processes).

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A controller for controlling information distribution for telemedical assistance being provided via a telemedicine workplace for a treatment carried out in a treatment room, the controller configured for:
receiving medical information from a medical modality or a storage system for medical information;
forwarding the received medical information to a display of the treatment room;
controlling the forwarding of the received medical information to the treatment room;
forwarding the received medical information to a display of the telemedicine workplace; and
controlling the forwarding of the received medical information to the telemedicine workplace.

2. The controller as claimed in claim 1, wherein the information includes at least one of the information types of images, image streams, control information and voice information.

3. The controller as claimed in claim 1, wherein the controller is configured for forwarding the received medical information in real-time.

4. The controller as claimed in claim 1, wherein controlling the forwarding of the received medical information comprises selecting the information.

5. The controller as claimed in claim 1, wherein forwarding the received medical information comprises forwarding visual information, and
wherein controlling the forwarding of the visual information includes configuring at least a part of the visual information for shared display.

6. The controller as claimed in claim 1, wherein controlling the forwarding of the received medical information comprises processing the received medical information.

7. The controller as claimed in claim 1, wherein the controller is configured for controlling the forwarding of the received medical information to the treatment room via an input interface that is provided in the treatment room.

8. The controller as claimed in claim 1, wherein the controller is configured for at least partially controlling the forwarding of the received medical information to the telemedicine workplace via an input interface that is provided in the treatment room.

9. The controller as claimed in claim 1, wherein the controller is configured for controlling the forwarding of the received medical information to the telemedicine workplace via an input interface that is provided for the telemedicine workplace.

10. The controller as claimed in claim 1, wherein the controller is configured for voice control.

11. The controller as claimed in claim 1, wherein the controller is configured for forwarding information received from the treatment room to the telemedicine workplace.

12. The controller as claimed in claim 1, wherein the controller is configured for forwarding information that is provided in the telemedicine workplace to the treatment room.

13. The controller as claimed in claim 1, wherein the controller comprises a program for selecting and collating information for forwarding.

14. A method of using a controller to monitor or control an industrial process at a first location from a remote location, the method comprising:
receiving information from a storage system for information;
forwarding the received information to a display of the first location;
controlling the forwarding of the received information to the first location;
forwarding the received information to a display of the remote location; and
controlling the forwarding of the received information to the remote location.

15. The method as claimed in claim 14, wherein the information includes at least one of the information types of images, image streams, control information and voice information.

16. The method as claimed in claim 14, wherein forwarding the received information comprises forwarding the received information in real-time.

17. The method as claimed in claim 14, wherein controlling the forwarding of the received information comprises selecting the information.

18. The method as claimed in claim 14, wherein controlling the forwarding of the received information comprises processing the received information.

19. The method as claimed in claim 14, further comprising forwarding information received from the first location to the remote location.

20. The method as claimed in claim 14, further comprising forwarding information that is provided in the remote location to the first location.
